(19) United States
(12) Patent Application Publication
(10) Pub. No.: US 2011/0080006 A1
(43) Pub. Date: Apr. 7, 2011

(54) Method

(76) Inventors: Werner Blau, County Dublin (IE); Ramesh Padamati, Dublin (IE); Anna Drury, County Dublin (IE)

(21) Appl. No.: 12/923,709

(22) Filed: Oct. 5, 2010

(30) Foreign Application Priority Data
Oct. 5, 2009 (IE) 2009/0777

(51) Int. Cl. F03G 7/00

(52) U.S. Cl. 290/1 R; 977/720

(57) ABSTRACT

A method for generating power from water by pressure retarded osmosis comprises the steps of: pumping sea water into a first pathway which is at least partially defined by a first face of a membrane, said membrane comprising a distinct electrically conductive porous nanotube layer; pumping fresh water into a second pathway which is at least partially defined by a second face of the membrane to generate an osmotic pressure gradient across the membrane; and harnessing the power generated from the osmotic pressure gradient.

### FIELD OF THE INVENTION

The invention relates to a method for generating power. In particular, the invention relates to a method for generating power using pressure retarded osmosis.

### SUMMARY OF THE INVENTION

According to the invention there is provided a method for generating power from water by pressure retarded osmosis, said method comprising the steps of:
pumping sea water into a first pathway which is at least partially defined by a first face of a membrane, said membrane comprising a distinct electrically conductive porous nanotube layer;
pumping fresh water into a second pathway which is at least partially defined by a second face of the membrane to generate an osmotic pressure gradient across the membrane; and
harnessing the power generated from the osmotic pressure gradient.

In one embodiment the electrically conductive porous nanotube layer comprise carbon nanotubes.

The electrically conductive porous nanotubes may be selected from one or more of: single walled nanotubes, double walled nanotubes, and multiwalled nanotubes.

The nanotube layer may have a porosity of between about 10% and about 20%.

In one case the nanotube layer has an average pore size of between about 0.04 μm and about 0.16 μm.

In one embodiment the electrically conductive porous nanotubes are arranged in a mat.

The electrically conductive porous nanotubes may be orientated in the layer.

At least some of the electrically conductive nanotubes may be functionalised.

The nanotubes may be functionalised with COOH and/or silver.

The membrane may comprise a support layer.

The support layer may comprise cellulose acetate.

The support layer may comprise nylon.

In one embodiment the support layer has a porosity of between about 85% to about 95%.

The support layer may comprise pores with an average size of at least 0.2 μm.

In one case the method further comprises the step of:
applying an alternating electric current to the electrically conductive porous nanotube layer.

The alternating electric current may be applied in the range of between about 20 to about 150V.

The alternating electric current may be applied in the range of between about 20 to about 10,000 Hz.

In another aspect the invention provides an apparatus for generating power from water by pressure retarded osmosis, said apparatus incorporating a membrane, comprising a distinct electrically conductive porous nanotube layer.

The pressure retarded osmosis membranes described herein may also be used to generate fresh water from salt water using reverse osmosis.

The electrically conductive porous nanotube layer may comprise carbon nanotubes.

The electrically conductive porous nanotubes may be selected from one or more of: single walled nanotubes, double walled nanotubes, and multiwalled nanotubes.

The nanotube layer may have a porosity of between about 10% and about 20%.

The nanotube layer may have an average pore size of between about 0.04 μm and about 0.16 μm.

In one embodiment the electrically conductive porous nanotubes are arranged in a mat.

The electrically conductive porous nanotubes may be orientated in the layer.

At least some of the electrically conductive nanotubes may be functionalised.

The nanotubes may be functionalised with COOH and/or silver.

In one case the membrane comprises a support layer.

The support layer may comprise cellulose acetate.

The support layer may comprise nylon.

The support layer may have a porosity of between about 85% to about 95%.

The support layer may comprise pores with an average size of at least 0.2 μm

According to the invention there is provided the use of a membrane comprising a support layer and an electrically conductive porous nanotube layer for generating power from water by pressure retarded osmosis.

The support layer may comprise a Bucky paper.

The membrane may comprise a strengthening layer. The strengthening layer may comprise cellulose acetate.

The electrically conductive nanotubes may be arranged in a mat. Alternatively, the electrically conductive nanotubes may be orientated with respect to the support layer.

The electrically conductive nanotubes may be carbon nanotubes.

The electrically conductive nanotubes may be single walled nanotubes and/or double walled nanotubes and/or multiwalled nanotubes.

The electrically conductive nanotubes may be functionalised. The nanotubes may be functionalised with COOH and/or silver.

The support layer may comprise a filter membrane. The filter membrane may comprise pores with an average size of about 0.2 μm. The filter membrane may comprise mixed cellulose esters and/or nylon 66 and/or fluoropore.

The nanotube layer may have a porosity of between about 10% and about 20%.

The strengthening layer may have a porosity of between about 85% to about 95%.

The nanotube layer may have an average pore size of between about 0.04 μm and about 0.16 μm.

The strengthening layer may have an average pore size of between about 0 μm to about 1 μm.

The water may be salt water, such as sea water. A salinity gradient concentration may be generated across the membrane.

The invention further provides a method for generating power from an osmotic pressure gradient generated across a membrane comprising a support layer and an electrically conductive porous nanotube layer comprising the steps of:
providing a membrane as described herein;
pumping salt water and fresh water across the membrane to create an osmotic difference across the membrane;
applying an alternating electric current to the electrically conductive porous nanotube layer; and
harnessing the power generated from the osmotic pressure gradient.

The alternating electric current may be applied in the range of between about 20 to about 150V.

The alternating electric current may be applied in the range of between about 20 to about 10,000 Hz.

### BRIEF DESCRIPTION OF THE DRAWINGS

The invention will be more clearly understood from the following description of an embodiment thereof, given by way of example only, with reference to the accompanying drawings, in which:

FIG. 1 is a scanning electron microscope image of a carbon nanotube layer (Bucky paper membrane) made with n-methyl-1-pyrrolidone (NMP) on top of a Millipore nylon filter membrane of pore size 0.45 μm;

FIG. 2 is a scanning electron microscope image of a carbon nanotube layer (Bucky paper membrane) made with sodium dodecyl sulphate (SDS) on top of a cellulose acetate filter of pore size 0.30 μm;

FIGS. 3A to D are scanning electron microscope images of a cellulose acetate/bucky paper composite. (A) is an image of the cellulose acetate layer, (B) is an enlarged image of the cellulose acetate layer, (C) is an image of the carbon nanotube layer, and (D) is an enlarged image of the carbon nanotube layer;

FIG. 4 is a schematic of a set up in which osmosis can be used to generate energy; and

FIG. 5 is a schematic of a test rig used to measure the hydrostatic pressure created by osmosis when fresh water flows from one chamber of the test rig to a chamber which contains higher salinity water.

### DETAILED DESCRIPTION OF THE INVENTION

The invention relates to a method to generate power from a salinity concentration gradient between fresh water and sea water using membranes based on carbon nanotubes which have the potential to achieve faster flows and thus create more energy than previous osmotic membranes.

The membranes described herein may be used in salinity power generation. Energy created by osmosis has very little impact on the environment and is renewable. Furthermore, there are no CO₂, emissions or toxic effluents, salts are not consumed in the process and there are no fuel costs. In addition, salinity power plants are flexible as regards, size and design. Salinity power plants can be built almost anywhere where there is good supply of fresh water and sea water and may be adapted to the local building environment, or combined with existing power stations, thus saving costs.

The pressure retarded osmosis membranes described herein may also be used to generate fresh water from salt water using reverse osmosis.

We describe the preparation of carbon nanotube (CNT) sheets and carbon nanotube/cellulose acetate composite membranes which can be used as pressure retarded osmosis membranes for the generation of power from salt water. The CNT sheets were prepared by dispersion of commercial multiwall (MW), doublewall (DW), and singlewall (SW) carbon nanotubes using surfactants or solvents, followed by vacuum filtration onto filter membranes such as cellulose acetate, nylon and PVDF, this generates a membrane that comprises a distinct carbon nanotube layer and a distinct support layer. The composite membranes of CNT and cellulose acetate are prepared by a phase inversion method by casting a cellulose acetate layer on top of bucky paper, this generates a membrane that comprises a distinct carbon nanotube layer, a composite carbon nanotube and cellulose acetate layer and a distinct cellulose acetate layer. The carbon nanotube layer of the membrane may be considered as the “active” layer and should be as thin as possible to reduce the likelihood of a build up of back pressure. The carbon nanotube layer is chemically inert which makes it particularly suitable for use in a pressure retarded osmosis membrane including. As the carbon nanotubes are electrically conductive, an electrical field (alternating current) may be applied across the membrane during the osmosis process to prevent fouling or clogging of the membrane and/or to control the amount of water transferred across the membrane. The support layer provides strength to the membrane to enable the membrane to withstand the pressures generated during the osmosis process. The support layer may be of any required thickness to provide structural integrity to the membrane so long as the support layer does not affect the performance of the “active” carbon nanotube layer. Depending on the type of membrane used the osmotic pressure generated was in the range of 30-400 Pa tested using a laboratory scale osmosis test rig.

The energy generated using a pressure-retarded osmosis process has little impact on the environment. The pressure retarded osmosis process described herein provides a cheap and renewable energy source. The osmotic pressure generated depends on the concentration gradient formed between both sides of the membrane; the concentration gradient is influenced by the membrane material. Thus the performance of the membrane is crucial for the success of pressure retarded osmosis as a cheap and renewable energy source and currently presents the major bottleneck for large-scale commercial feasibility. Many commercial membranes allow for very high water permeability, but also possess high salt permeability. In order to generate a high head of pressure build-up, membranes having only high water permeability are required. The currently available cellulose acetate membranes tend to clog very easily due to a build of salt on the membrane surface. The salt also interacts with polymer materials in the membrane itself resulting in further clogging of the membranes [S. S. Madaeri, 1999]

We describe the fabrication of semi-permeable membranes which can be used as pressure-retarded osmosis membranes in salinity power generation. Two types of membrane were fabricated:
1) Carbon nanotube sheets
2) Carbon nanotube/cellulose acetate composite membranes

Molecular simulations have indicated that carbon nanotube membranes are about 10,000 times more efficient than the commercially available synthetic membranes for pressure retarded osmosis [Hummer 2001]. In addition, carbon nanotube membranes are chemically inert and have high thermal stability compared to polymer based membranes [H. Dai, 2002 and A. Srivasta et al., 2004]. The water flow through a CNT has been measured by Holt et al from the Lawrence Livermore National Laboratory under the auspices of the US Department of Energy and is comparable to flow rates extrapolated from molecular dynamic simulations [Hummer 2001, Murata 2000, Majumder 2005, Tess 1996, Berezhkovskii 2002].

The invention will be more clearly understood from the following non-limiting examples thereof.

### EXAMPLE 1

### Carbon Nanotube Sheets

Carbon nanotube “Bucky” papers on top of commercial nylon filters of 0.45 μm pore size were prepared.

MWCNTs, DWCNTs, SWCNTs and functionalised CNTs were dispersed in N-methyl-1-pyrrolidone (NMP) as follows:

TABLE 1
Details of amount and type CNTs used
with amounts of dispersant (NMP)

| | | | Amount | Amount |
|---|---|---|---|---|
| Membrane | | | used | NMP |
| No | CNT type | Manufacturer | (mg) | (mL) |
| 1 | Nanocyl 3100 | Nanocyl | 20 | 400 |
| 2 | Thin MWCNTs, | | 60 | 1200 |
| 3 | produced via CCVD | | 60 | 1200 |
| | process purified | | | |
| | to greater than | | | |
| | 95% carbon, | | | |
| | then functionalized | | | |
| | with COOH. | | | |
| 4 | Nanocyl 1100 | Nanocyl | 40 | 800 |
| | SWCNTs produced | | | |
| | via ccvd, | | | |
| | then purified to | | | |
| | greater than | | | |
| | 70% carbon | | | |
| | and functionalized | | | |
| | with COOH. | | | |
| 5 | Nanocyl SA | Nanocyl | 10 | 200 |
| | DWCNTs | | | |
| 6 | SWCNTs | NRJ | 40 | 800 |
| | NRJ21 | | | |

Nanocyl 3100 was purified in house by refluxing with 18% HCl for 12 h at 100° C., followed by filtration, washing with H₂O and drying in a CVD furnace at 400° C.

The dispersion was carried out as follows:

Ten 20 mL vials each containing 2 mg CNTs and 20 mL NMP were sonicated using a sonic tip for 5 min at 38% amplitude to disperse the CNTs in the solvent and break up nanotube aggregates. The contents were then added to a 500 mL round bottomed flask and diluted 100% by adding 200 mL NMP. This was sonicated in a sonic bath for 3-4 hrs to ensure the nanotubes were fully dispersed in the solvent. The suspension was then centrifuged to remove impurities and large carbon aggregates and finally filtered onto a nylon membrane in a Buckner flask to leave a uniform layer or mesh of CNTs on the surface of the membrane. The filtrand (residue) was washed with deionised water (1 L) and then (together with the membrane) removed and dried overnight in a vacuum oven at 40° C. to ensure complete removal of the solvent.

### EXAMPLE 2

### Carbon Nanotube Sheets

Carbon nanotube “Bucky” papers on top of mixed cellulose ester filters of 0.30 μm pore size were prepared.

TABLE 2
Details of amount and type CNTs used with
amounts of dispersant (SDS or AQ)

| | | | Amount | Amount SDS | |
|---|---|---|---|---|---|
| Membrane | | | used | or AQ | |
| No | CNT type | Manufacturer | (mg) | (mg) | |
| 1 | Nanocyl 3100 | Nanocyl | 12 | 600 | (SDS) |
| 2 | Thin MWCNTs, | | | | |
| 3 | produced via | | 24 | 600 | (SDS) |
| 4 | CCVD process | | 90 | 400 | (SDS) |
| | purified to | | 90 | 400 | (SDS) |
| | greater than | | | | |
| | 95% carbon, | | | | |
| | then functional- | | | | |
| | ized with COOH. | | | | |
| | Purified in house. | | | | |
| 5 | Nanocyl 3100 | Nanocyl | 20 | 40 | (AQ) |
| 6 | MWCNTs | | | 60 | (AQ) |
| 7 | Nanocyl SA | Nanocyl | 40 | 80 | (AQ) |
| | DWCNTs | | | | |
| 8 | AgMWCNTs | Nanocyl | 20 | 40 | (AQ) |
| | Functionalised | | | | |
| | in house | | | | |

MWCNTs, DWCNTs, SWCNTs and functionalised CNTs were dispersed in Sodium dodecyl sulphate (SDS) -an ionic surfactant and Nanodisperse AQ - a non-ionic surfactant as shown in Table 2 above. Nanocyl 3100 was purified in house by refluxing with 18% HCl for 12 h at 100° C., followed by filtration, washing with H₂O and drying in a CVD furnace at 400° C.

Silver particles were incorporate onto MWCNTs as follows:

MWCNT (Nanocyl 3100) were first dispersed in a non-ionic surfactant (Nanodisperse AQ in water) and sonicated for 10 minutes. A solution of silver nitrate (Aldrich 209139) in water was added to this and stirred continuously for 4 hours. The dispersion was then transferred into an open tray and placed in a fume cupboard to allow the water to evaporate. The resulting silver nitrate-MWCNT composite was heated to 400° C. (at a rate of 30° C./min) and held at that temperature for 3 hours so that the silver nitrate was reduced to silver. The modified tubes were then washed with deionised water in a sonic bath and dried at room temperature. TGA and EDAX analysis indicated that between 20-40% Ag was present

Bucky papers were prepared with the dispersant SDS (Membranes 1-4) as follows:

A 1% solution of SDS in deionised water was prepared and left stirring overnight to ensure complete dispersion of the SDS. 4.5 mg of CNTs and 20 ml of this SDS solution were added to 20 vials each of 20 mL capacity. The vials were sonicated using a sonic tip for 5 min at 38% amplitude, then combined into a 500 mL round bottomed flask and sonicated in a sonic bath for 4 hours. The dispersion was then slowly filtered through a cellulose ester filter on a Buchner funnel and washed with copious amounts of deionised water until the surfactant was completely removed (no more bubbles appeared in the filtrate). The membrane was then removed and dried overnight in a vacuum oven at 40° C. to ensure complete removal of the solvent.

Bucky papers were prepared with the dispersant Nanodisperse AQ (membranes 5-8) as follows: 0.01 g CNT were placed in a 20 mL vial and 10 mL of deionised water added. This was agitated using an ultrasonic probe (2 min) and 0.02 g Nanodisperse AQ then added to the vial. This was again agitated using an ultrasonic tip (2 min) and 180 mL of deionised water added.

### EXAMPLE 3

### Carbon Nanotube/Cellulose Acetate Composite Membranes

Carbon nanotube/cellulose acetate composite membranes are prepared by making a free-standing Bucky paper and casting a cellulose acetate membrane on top of it.

MWCNT from Nanocyl (Nanocyl 3100) were purified as described in Example 2. The cellulose acetate was purchased from Sigma Aldrich and used without further purification.

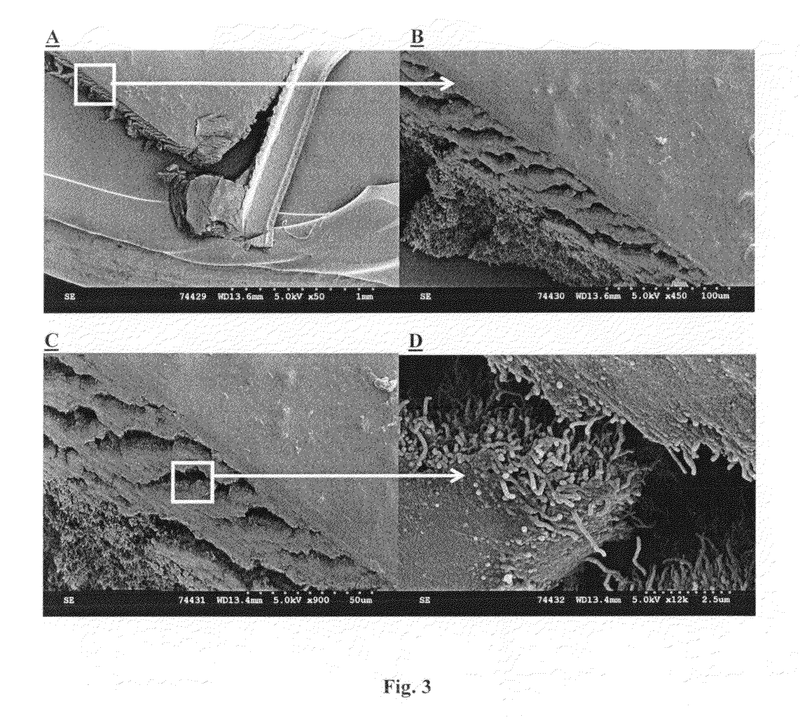

The Bucky paper was prepared with SDS as described in Example 2 above but using an alumina membrane instead of mixed cellulose esters in the Buchner funnel. When dry the Bucky paper peeled off the alumina membrane and was found to be between 70-140 μm thick and weighed 0.5 mg. The Bucky paper was then adhered to a glass slide and a cellulose acetate layer cast on 20 top of it by the phase inversion method. The cellulose acetate layer was made by dissolving 8.45 g cellulose acetate in 27.62 g dioxane, 10.57 g acetone, 5.07 g acetic acid and finally 8.45 g methanol, stirring at room temperature until the cellulose acetate was completely dissolved (usually one day) and using a clean glass rod, pulling the solution over the glass plate. It was and left to evaporate in air for about 15 seconds, then placed in an ice bath for about 2 hours and 15 minutes at a temperature between about 0 to about 4° C. followed by annealing for about 15 minutes at a temperature between about 80 to 85° C. Referring to FIG. 3, SEM analysis showed that this composite membrane consists of 3 distinct layers, a smooth dense top layer of cellulose acetate (FIGS. 3A and B) a porous composite layer of cellulose acetate with embedded nanotubes (FIGS. 3C and D) and a bucky paper layer composed of pure CNTs at the bottom.

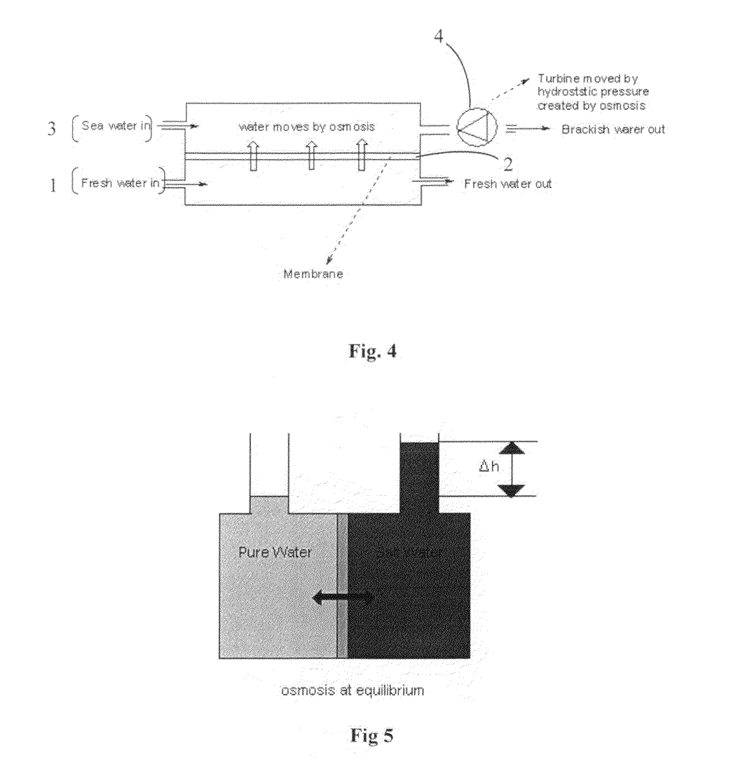

The membrane was tested in the osmosis rig (shown in FIG. 5). After 24 h in the rig the hydrostatic pressure head Δh was measured as 2 cm and the hydrostatic pressure calculated from equation 2

ΔP=ρ.g.Δh (Equation 1)

Where ρ=density of the solution, g=acceleration due to gravity and Δh is the height difference or relative height of the fluid column (in meters).

At equilibrium the osmotic pressure ΔΠ is equal to the hyrdostatic pressure ΔP and can be calculated from equation 1. In this case an osmotic pressure of 219.20 Pa was achieved.

The efficiency of the membrane was calculated from equation 2

Δπ=i.η.R.T.ΔC (Equation 2)

Where:
Δπ: Pressure (Pa)
ΔC: Difference in concentration on the salt water side (mol/L)
η: Efficiency of the membrane
R: the universal gas constant
T: the temperature (K) and
i: number of ions per molecule (in this case 2 for salt).

An efficiency of 8.6% was obtained in this case.

### EXAMPLE 4

### Characterisation of Carbon Nanotube Sheets

The porosity of the Bucky papers prepared with various types of nanotubes was measured by Archimedes principal (Equation 3) and found to be between 10-20%

$$Porosity = \frac{{m}_{wet} - {m}_{dry}}{{V}_{total}} \qquad ( Equation 3 )$$

Wherein:
m_{wet}=mass of membrane which had been soaked in water for 24 h, then mopped with blotting paper;
m_{dry}=mass of soaked membrane after it had been dried in a vacuum oven at 40° C. overnight; and
vₜₒₜₐₗ=volume of the membrane calculated by using the formula for the volume of a disc Πr²h, where r=radius of the membrane and h=thickness

Carbon Nanotube Bucky Papers on Top of Commercial Nylon

The thickness of the Bucky paper was measured with a digital micrometer and found to be 0.01 mm±0.005 mm (including the commercial backing).

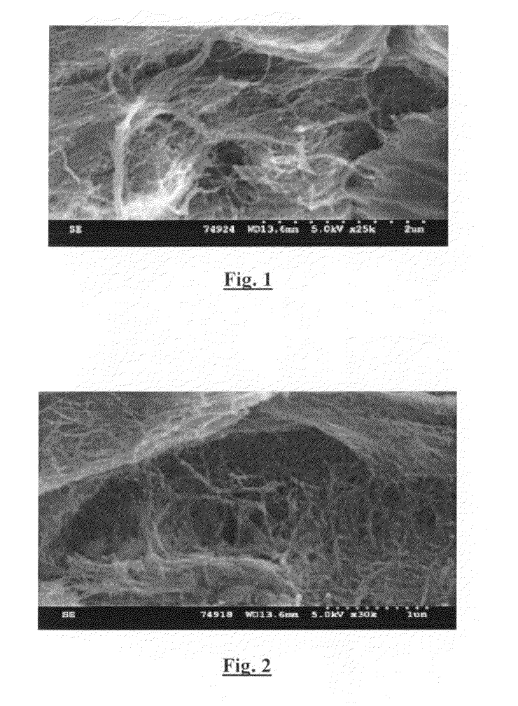

The pore sizes were measured from the Scanning Electron Microscope (SEM) image of FIG. 1 using an image tool software and were found to be between about 0.04-0.09 μm±0.01 μm

The Bucky paper with the best results in the osmotic pressure test rig experiments was made using the commercially available Nanocyl 3100 carbon nanotubes (purchased from Nanocyl) that were purified in house. This Bucky paper was found to have an osmotic pressure of 431.64 Pa and an efficiency of 17.68% when compared to the value achieved by a commercial semi-permeable membrane in the test rig.

Carbon Nanotube Bucky Papers on Top of Mixed Cellulose Ester Filters

The best Bucky paper made with the SDS (purified Nanocyl 3100) was found to be 0.10 mm thick (including the backing) and have a porosity of 17%. The pore sizes were measured from the scanning electron microscope image of FIG. 2 using an image tool software SEM and were found to be between 0.04 and 0.16 μm±0.01μm.

The Bucky paper was found to have an osmotic pressure of 29.43 Pa and an efficiency of 1.20% when compared to the value achieved by a commercial semi-permeable membrane in the test rig.

Table 3 below lists the percentage porosity for the various Bucky membranes tested.

TABLE 3
Porosity Data of various bucky paper membranes

| Nanotube type and dispersant | porosity |
|---|---|
| Ag MWCNT + water + nanosperce AQ | 19% |
| DWCNT purified + water + nanosperce AQ | 18% |
| DWCNT purified + NMP | 18% |
| nanocyl 3100 purified + water + a little AQ | 15% |
| nanocyl 3100 purified + water + a lot of AQ | 15% |
| nanocyl 3100 purified + SDS (12 mg) | 15% |
| nanocyl 3100 purified + SDS (24 mg) | 15% |
| nanocyl 3100 purified + SDS (90 mg) | 17% |
| nanocyl 3100 purified + NMP (20 mg) | 10% |
| nanocyl 3100 purified + NMP (60 mg) | 11% |

Unlike the commercially available membranes, the membranes described herein have the advantage of hydrophobicity and electrical conductivity as the amount of water transferred across the membrane (throughput) can be controlled by applying an electric field across the membranes.

### EXAMPLE 5

### Generating Power

Gerstandt et al, outlines the necessary membrane parameters for effective osmotic performance for power generation. The authors describe a structure parameter S defined as:

$$S = x \cdot \frac{τ}{ϕ} \qquad ( Equation 4 )$$

Where:
× is the thickness of the porous layer;
τ is the tortuosity; and
φ is the porosity.

The desired value for this parameter is less than 0.0015 m (1.5×10⁻³ m).

A power parameter W, defined as:

W=J_{w}·Δp (Equation 5)

Where:
J_{w} is the fresh water flux (calculated as A(Δπ−Δ“p”)) and
Δₚ is the hydrostatic pressure difference across the membrane.

For a commercial pressure retarded osmotic system, W needs to be in the range of 4-6 W/m².

With our membrane the porous layer thickness is of the order of 100 μm (10⁻⁴ m), the tortuosity is expected in the 2-3 range (actual path length taken divided by the thickness). The porosity is of the order 20%. This gives a Structure parameter value of:

$$S = {10}^{- 4} \cdot \frac{2}{0.2} = {10}^{- 3} \qquad ( Equation 6 )$$

Which is ⅔ of the desired value quoted above. For an ideal thickness of 100 nm, S becomes 10⁻⁶. This is 1,000 times better than the desired value.

Since the pressure difference is mainly given by the salt concentration gradient and the same for any idealised membrane, we can compare the power parameter (equation 5) for a state-of-the-art synthetic cellulose membrane with the power parameter of a CNT nanomembrane as follows: Molecular dynamics simulations have demonstrated that water transport through hydrophobic Carbon nanochannels is similar to transport through natural Aquaporine protein channels and they can conduct water in the same fashion (Hummer 2001). Aquaporines posses water transport properties of 51,000 L/m²h (Zhu 2001). It has been reported that both single-walled and multi-walled tubes transport water in the same way (Majumder 2005). Further results have shown that water transport in Nanocarbon membranes appears to be almost frictionless with flow rates of around 50,000 L/m²h (Murata 2000, Majumder 2005, Tess 1996, Berezhkovskii 2002). State-of-the art high-performance synthetic cellulose membranes on the other hand have water transport properties in the range 5-30 L/m²h only (EU ‘Salinity’ 2001). Hence we can define the ratio between the power parameter of a Carbon Nanotube membrane and a synthetic state-of-the-art membrane as:

W_{CNT}/W_{synth}=J_{CNT}/J_{synth}˜50,000/25=2,000 (Equation 7)

Therefore, CNT membranes are about 2,000 times more efficient that current synthetic membranes.

The membranes described herein are suitable for use in pressure retarded osmosis for the generation of power.

The results from the osmosis test rig demonstrate that when salt water is separated by fresh water an osmotic pressure gradient can be generated using the carbon nanotube Bucky papers (membranes) described herein (carbon nanotube sheets and carbon nanotube/cellulose acetate composite membranes). We have demonstrated the potential use of such membranes for efficient and renewable salinity power generation using reverse osmosis systems. Referring to FIG. 4, the schematic demonstrates how hydrostatic pressure created by osmosis across a membrane 2 to sea water 3 can be used to turn a turbine 4 which can then be used to create energy.

Membrane fouling or ‘clogging’ is a known issue with commercial salinity power plants. The main substances which cause membrane fouling are salts, soluble polymers, superfine colloidal particles, bacteria growing colonising the inside of membrane pores, and biofilms. It is known that these substances have the most influence on membrane decreasing throughput of the membrane during the osmosis process. In order to overcome this problem the membranes described herein comprise a bucky paper as a conducting layer which allows for an electric field to be applied across the membrane. It is envisaged that applying an electric field across the membrane during the osmosis process will help the diffusion of charged particles from membrane surface by thinning the sedimentation layer near the membrane surface thus helping to maintain constant membrane throughput throughout the power generation.

The invention is not limited to the embodiment hereinbefore described, with reference to the accompanying drawings, which may be varied in construction and detail.

### REFERENCES

S. S. Madaeri. Warer res. 33/2:301 (1999)

A. Srivastava et al. Nature Materials 3:610 (2004)

H. Dai. Acc. Chem. Res. 35:1035 (2002)

J. Holt et al. Science 312:1034 (2006)

G. Hummer et al. Nature 414:188 (2001)

K. Murata et al. Nature 407:599 (2000)

M. Majumder et al. Nature 438:55 (2005)

A. Tess, Science 273:483 (1996)

A. M. Berezhkovskii et al. Phys Rev E65, Art No 060201 (2002)

EU ‘Salinity Power’ Industrial Partnership: ENK6-CT-2001-00504; http://www.gkss.de/euprojekte/PSP6/Salinity_Power.htm ttpl

F Zhu et al, FEBS Lett 2001, 504, 212 and Biophysical Journ 2003, 85, 236

1. A method for generating power from water by pressure retarded osmosis, said method comprising the steps of:
pumping sea water into a first pathway which is at least partially defined by a first face of a membrane, said membrane comprising a distinct electrically conductive porous nanotube layer;
pumping fresh water into a second pathway which is at least partially defined by a second face of the membrane to generate an osmotic pressure gradient across the membrane; and
harnessing the power generated from the osmotic pressure gradient.

2. The method as claimed in claim 1 wherein the electrically conductive porous nanotube layer comprise carbon nanotubes.

3. The method as claimed in claim 1 wherein the electrically conductive porous nanotubes are selected from one or more of: single walled nanotubes, double walled nanotubes, and multiwalled nanotubes.

4. The method as claimed in claim 1 wherein the nanotube layer has a porosity of between about 10% and about 20%.

5. The method as claimed in claim 1 wherein the nanotube layer has an average pore size of between about 0.04 μm and about 0.16 μm.

6. The method as claimed in claim 1 wherein the electrically conductive porous nanotubes are arranged in a mat.

7. The method as claimed in claim 1 wherein the electrically conductive porous nanotubes are orientated in the layer.

8. The method as claimed in claim 1 wherein at least some of the electrically conductive nanotubes are functionalised.

9. The method as claimed in claim 8 wherein the nanotubes are functionalised with COOH and/or silver.

10. The method as claimed in claim 1 wherein the membrane comprises a support layer.

11. The method as claimed in claim 10 wherein the support layer comprises cellulose acetate.

12. The method as claimed in claim 10 wherein the support layer comprises nylon.

13. The method as claimed in claim 10 wherein the support layer has a porosity of between about 85% to about 95%.

14. The method as claimed in claim 10 wherein the support layer comprises pores with an average size of at least 0.2 μm.

15. The method as claimed in claim 1 further comprising the step of:
applying an alternating electric current to the electrically conductive porous nanotube layer.

16. The method as claimed in claim 15 wherein the alternating electric current is applied in the range of between about 20 to about 150V.

17. The method as claimed in claim 15 wherein the alternating electric current is applied in the range of between about 20 to about 10,000 Hz.

18. An apparatus for generating power from water by pressure retarded osmosis, said apparatus incorporating a membrane, comprising a distinct electrically conductive porous nanotube layer.

19. The apparatus as claimed in claim 18 wherein the electrically conductive porous nanotube layer comprise carbon nanotubes.

20. The apparatus as claimed in claim 18 wherein the electrically conductive porous nanotubes are selected from one or more of: single walled nanotubes, double walled nanotubes, and multiwalled nanotubes.

21. The apparatus as claimed in claim 18 wherein the nanotube layer has a porosity of between about 10% and about 20%.

22. The apparatus as claimed in claim 18 wherein the nanotube layer has an average pore size of between about 0.04 μm and about 0.16 μm.

23. The apparatus as claimed in claim 18 wherein the electrically conductive porous nanotubes are arranged in a mat.

24. The apparatus as claimed in claim 18 wherein the electrically conductive porous nanotubes are orientated in the layer.

25. The apparatus as claimed in claim 18 wherein at least some of the electrically conductive nanotubes are functionalised.

26. The apparatus as claimed in claim 25 wherein the nanotubes are functionalised with COOH and/or silver.

27. The apparatus as claimed in claim 18 wherein the membrane comprises a support layer.

28. The apparatus as claimed in claim 27 wherein the support layer comprises cellulose acetate.

29. The apparatus as claimed in claim 27 wherein the support layer comprises nylon.

30. The apparatus as claimed in claim 27 wherein the support layer has a porosity of between about 85% to about 95%.

31. The apparatus as claimed in claim 27 wherein the support layer comprises pores with an average size of at least 0.2 μm
